(19) United States
(12) Patent Application Publication
(10) Pub. No.: US 2010/0147770 A1
(43) Pub. Date: Jun. 17, 2010

(54) FUNCTIONALIZED CARBON SORBENT AND PROCESS FOR SELECTIVE CAPTURE OF PRESELECTED METALS

(76) Inventors: Glen E. Fryxell, Kennewick, WA (US); William D. Samuels, Richland,, WA (US)

Correspondence Address: BATTELLE MEMORIAL INSTITUTE;ATTN: IP SERVICES, K1-53, P. O. BOX 999, RICHLAND, WA, 99352, US

(21) Appl. No.: 12/334,311

(22) Filed: Dec. 12, 2008

(51) Int. Cl. C07C 321/26; C07C 25/22; B01J 19/00; C07C 381/02; C02F 1/28

(52) U.S. Cl. 210/688; 570/183; 560/308; 568/23

(57) ABSTRACT

A composition and process are described that provide for selective capture of targeted materials, including metals and chemical targets. The composition includes an activated carbon scaffold that is chemically modified to include ligands with a high affinity for selective capture of metals and chemical targets. The invention finds use, e.g., as heavy metal sorbents, as catalyst supports, in analytical applications such as ion chromatography, and in devices such as analytical instruments and chemical sensors.

This invention was made with Government support under Contract DE-AC05-76RL01830 awarded by the U.S. Department of Energy. The Government has certain rights in the invention.

### FIELD OF THE INVENTION

The present invention relates generally to sorbent materials and catalyst supports. More particularly, the invention relates to a chemically modified activated carbon sorbent and process for selective capture of preselected metals.

### SUMMARY OF THE INVENTION

In one aspect, the present invention is a composition that includes a carbon scaffold. The scaffold is comprised of an activated carbon that is chemically modified to include a nucleofugic (leaving) group. Leaving groups are molecules or molecular fragments that attach to chemical moieties or substituents of the scaffold. The nucleofugic group is chemically attached to the scaffold, e.g., through a chemical or functional group of the scaffold. In one embodiment, the chemical or functional group that attaches the leaving group to the scaffold is a benzylic carbon. In various embodiments, the nucleofugic group of the scaffold includes such substituents as, e.g., —Cl, —Br, —I, sulfates, organosulfonates, tosylates, mesylates, and combinations of these substituents. Other leaving groups of the composition include chloroalkyl leaving groups, e.g., chloromethyl groups, chloroethyl groups, chloropropyl groups, chlorobutyl groups, and the like, and combinations thereof. Leaving groups are displaced in nucleophilic substitution reactions with nucleophiles (electron donor species) or other chemical substituents to form additional chemical species. For example, leaving groups, when displaced, allow for the chemical attachment of a variety of preselected ligands to the carbon scaffold. These added ligands are chemical substituents that provide the composition with the ability to selectively bind to a metal(s), e.g., as ion(s) or as complexes, or to a selected chemical. In various embodiments, ligands are built from a sulfur-containing nucleophile, e.g., thiosulfate, thiourea, thioacetate, including combinations of these nucleophiles. In various other embodiments, the ligand can be selected from: thiols, amines, carboxylates, phosphines, phosphites, phosphonates, enolates, carbanions, alkoxides, thiolates, including combinations of these ligands. In one embodiment, the preselected ligand is a thiol (S—H) that is chemically bound to a benzylic carbon of the activated carbon scaffold. The composition finds use, e.g., as a sorbent for selective capture of various metals, selective capture of chemicals, e.g., forming various chemical adducts and chemical complexes, and as catalyst supports. As a sorbent comprising the thiol ligand, for example, the composition selectively binds metals including, but not limited to, e.g., heavy metals, toxic metals, transition metals, and rare earth metals. In a preferred embodiment, the sorbent binds to metals that include, e.g., mercury (Hg), lead (Pb), cadmium (Cd), silver (Ag), copper (Cu), cobalt (Co), arsenic (As), including combinations of these metals. The composition also finds use in various analytical applications and methods, including, e.g., ion chromatography. In one embodiment, the composition of the invention is used as a chromatographic phase in an ion chromatography application. Elution of metal ions through a column containing this tailored composition allows for separation of the various metals. Differential binding of different metal ions results by the sorbent provides a different elution profile for each of the different metal ions allowing for separation. In the composition, the activated carbon scaffold has an inherent nanoporous structure. Surface area is preferably greater than about 800 m²/g. More preferably, the scaffold has a surface area of from about 1000 m²/g to about 2000 m²/g. Most preferably, the scaffold has a surface area of from about 1200 m²/g to about 1800 m²/g. In an exemplary test described herein, the carbon scaffold of the composition had a surface area of about 1450 m²/g, which is not limited. In other embodiments, the scaffold has a surface area selected in the range from about 800 m²/g to about 2500 m²/g. In one embodiment, the scaffold includes a surface area greater than about 1200 m²/g. Pores of the activated carbon scaffold are generally of a size in the range of from about 1 nm to about 100 nm. More preferably, pores of the activated carbon scaffold are of a size in the range of from about 1 nm to about 40 nm. Most preferably, pores of the activated carbon scaffold are of a size in the range of from about 1 nm to about 10 nm, but pore sizes are not limited thereto.

In another aspect, the invention is a method of making a metal-selective sorbent composition. The method includes the step of chemically attaching a preselected ligand to a preselected chemical group of an activated carbon scaffold.

In another aspect, the invention is a method of making a selective sorbent composition. The method includes the steps of chemically attaching a preselected nucleofugic group to a preselected chemical group of an activated carbon scaffold; and displacing the nucleofugic group and chemically attaching a preselected ligand to the scaffold. The ligand provides the sorbent with the ability to selectively capture a preselected metal(s) or chemical(s).

In another aspect, the invention is a method of using a sorbent. The method includes the step of chemically binding a preselected metal(s) present in a fluid to a ligand that is chemically attached to a preselected functional or chemical group of an activated carbon scaffold, i.e., an anchored ligand. The ligand provides selective capture of a preselected metal(s) from the fluid. In a preferred embodiment, the step of binding the ligand includes attaching the ligand to a benzylic carbon, which involves a chloromethylation reagent or process. The chloromethylation of the activated carbon scaffold results in the formation of a useful synthon that is easily modified in a variety of different ways. For example, aromatic groups of an activated carbon scaffold can be chemically modified by chloromethylation to form benzylic chloride (end) groups. The chloride leaving group is easily displaced to attach these anchored ligands which provide selective binding of specific metals or other chemical entities. In one embodiment, e.g., chloromethylation provides chloromethylated end groups that are easily displaced with thiosulfate to form a thiosulfate intermediate. Hydrolysis of the thiosulfate end groups forms thiols that yield a thiol-activated carbon product. The thiol ligands provide for selective capture of heavy and toxic metals, e.g. mercury, lead, arsenic, and like metals. In one embodiment, the method includes chemically modifying aromatic ring sites of an activated carbon scaffold replacing, e.g., an aryl hydrogen atom with a chemical substituent that forms an electrophilic attachment site on the activated carbon scaffold, i.e., a site that accepts an electron donor. In one embodiment, electrophilic attachment sites of the activated carbon scaffold are benzylic carbons that include nucleofugic (leaving) groups. In other embodiments, the electrophilic attachment sites include a benzylic carbon that further bear electronegative halogen atoms, e.g., —Cl, —Br, or —I. In a preferred embodiment, the benzylic carbon attachment sites are prepared using a chloromethylation reagent or process that chemically modifies the carbon scaffold. The attachment sites of the chemically modified scaffold can be further modified to include a variety of preselected (anchored) ligands that selectively bind with preselected metal(s) or other chemical moieties that secure the metal(s) or chemical moieties to the scaffold.

In another aspect, the invention is a method for selective capture of a preselected metal(s) using a thiol-activated carbon sorbent. The sorbent comprises a carbon scaffold that includes thiol ligands anchored at preselected attachment sites of the scaffold. The method includes the step of selectively capturing a preselected metal(s) present in a fluid on the sorbent in contact with the fluid. The sorbent selectively captures the preselected metal(s) thereto by binding the metal(s) to the thiol (S—H) groups of the sorbent.

### BRIEF DESCRIPTION OF THE DRAWINGS

FIG. 1 is a schematic that shows a process for chloromethylation of an activated carbon starting material, according to a process of the instant invention.

FIG. 2 is a schematic that shows a process for introducing a thiol end functional group to the activated carbon scaffold of FIG. 1, according to a process of the instant invention.

FIG. 3 is a plot showing kinetics for sorption of (Hg) metal by an activated carbon scaffold composition functionalized with thiol (AC—CH₂—SH), according to an embodiment of the invention.

### DETAILED DESCRIPTION

Activated carbon is a carbon material with a highly vascular structure (scaffold or backbone) that is activated by heating the material at a high temperature (e.g., 600° C. to about 1000° C.) under an inert atmosphere and/or oxidizing the material, e.g., with acid or base. Activated carbon is not structurally homogeneous. Activation yields a carbon scaffold (structure or backbone) having a diversity of chemical moieties with desirable functionalization, i.e., reactive functional or chemical groups. These chemical moieties include, but are not limited to, e.g., carboxylic acids (—COOH); alcohols (—OH); aldehydes (—C═O); ketones; lactones; and other oxygen-containing moieties; aromatic hydrocarbons containing, e.g., from 1 to 6 aromatic rings including, but not limited to, e.g., anthracenes, napthalenes; furans (e.g., benzofurans; di-benzofurans); phenols; and other aromatic ring systems. Activated carbon with its diversity of chemical moieties is useful for many varied applications. For example, activated carbon can be further chemically modified to enhance its chemical affinity for various target materials by introducing specific chemical functionality or end groups to the carbon structure (scaffold or backbone). The modified activated carbon can be used as a highly selective metal sorbent to capture, concentrate, and decrease concentrations of toxic metals, e.g., in contaminated waterways. The composition also finds use, e.g., as a catalyst support. The composition also finds uses in ion chromatography, in sensors, and like instruments and devices. No limitations are intended. A process for chemically modifying the structure of the activated carbon scaffold (backbone) will now be described.

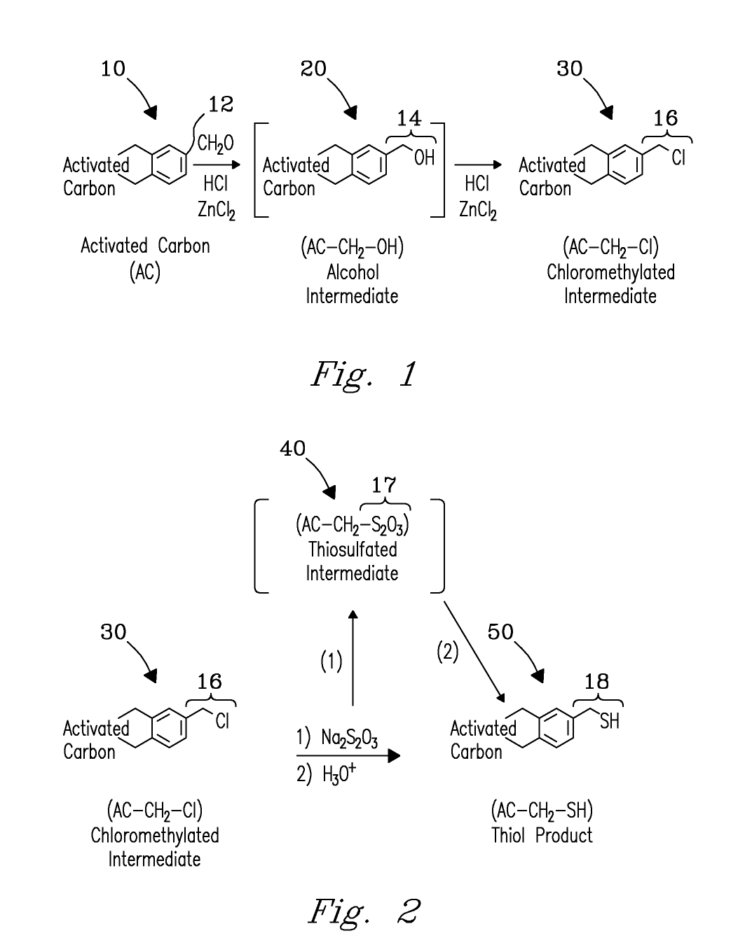

FIG. 1 presents a process for chemically modifying the backbone structure (scaffold) of an exemplary activated carbon 10, according to a preferred embodiment of the invention. The process attaches preselected end groups at specified locations in the scaffold. While chemical modification of aromatic moieties is described, the invention is not limited thereto. For example, as described herein, activated carbon contains a diversity of chemical moieties that provide many varied routes for chemical modification of the scaffold. In the figure, activated carbon 10 is shown as a single aromatic ring system, but is not limited thereto. In the instant process, activated carbon 10 is chemically modified through, e.g., electrophilic substitution reactions directed at, e.g., a substitution site 12 of an aromatic ring present in the scaffold. Here, chloromethylation of the carbon scaffold typically involves treating the activated carbon with formaldehyde (CH₂O) or a formaldehyde precursor in the presence of an acid and a catalyst. A preferred catalyst is zinc chloride (ZnCl₂) and an exemplary acid is hydrochloric acid (HCl), but the invention is not limited thereto. The reaction adds an alcohol end group (—CH₂OH) 14 to an aromatic group present in the scaffold (backbone) of the activated carbon, forming an alcohol intermediate 20, e.g., benzyl alcohol (denoted as AC—CH₂—OH). The alcohol end group (—CH₂OH) 14 of the alcohol intermediate (AC—CH₂—OH) 20 is subsequently converted to a chloride end group 16 by reaction with HCl and ZnCl₂, forming a chloromethylated intermediate 30, e.g., a benzyl chloride (denoted as AC—CH₂—Cl). Chloromethylation of the activated carbon proceeds smoothly. Surface area and pore size distribution of the intermediate product indicates no significant crosslinking of the activated carbon occurs during the chloromethylation reaction under these conditions. In the instant embodiment, while the carbon scaffold (backbone) is modified (i.e., chloromethylated) using a —CH₂Cl chemical group to form a chloromethylated intermediate, the invention is not limited thereto. In other embodiments, the carbon backbone can be modified using other chemical groups, e.g., primary and secondary alkyl groups that include, but are not limited to, e.g. chloroethyl [—CH(CH₃)—Cl] groups, chloropropyl [—CH(Et)-Cl] groups, and like moieties. Further, in the instant embodiment, while use of a chloride (—Cl) leaving group is described, other acids can also be used (e.g. HBr) which will result in formation of other leaving groups (e.g. Br, I, sulfates, organosulfonates, tosylates, mesylates, and other moieties) at the benzyl position in place of the Cl. Thus, no limitations are intended. The process can also be used with other chemical moieties, e.g., aldehydes, acetals, enol ethers, acetylenes, and the like, which will result in formation of other intermediates with leaving groups located at the benzylic position.

FIG. 2 presents a process that converts the chloromethylated intermediate 30 (AC—CH₂—Cl) of FIG. 1 to a thiol product 50 (denoted as AC—CH₂—SH). The thiol product contains thiol end groups (—SH) 18 which are anchored to the scaffold (backbone) of the activated carbon 10. Conversion of the chloromethylated intermediate 30 (AC—CH₂—Cl) to thiol end product 50 (AC—CH₂—SH) is rapid and is easily achieved. Primary and secondary alkyl halides can be readily converted to corresponding thiols. The halide is displaced typically with, e.g., a sulfur-containing nucleophile, which displaces the leaving group of the intermediate and ultimately results in formation of the desired thiol. Sulfur-containing nucleophiles include, but are not limited to, e.g., thiosulfate anion, thiourea, thioacetate, and like sulfur-containing nucleophiles. In the figure, for example, displacement of chloride in the chloromethylated intermediate 30 with thiosulfate anion (an S_{N}2-type reaction) forms a thiosulfate end group (—S₂O₃) 17 that yields a thiosulfate intermediate 40 (denoted as AC—CH₂—S₂O₃), which can be verified by elemental analysis. Alkylthiosulfate end groups (—S₂O₃) 17 in the thiosulfate intermediate 40 (AC—CH₂—S₂O₃) are hydrolyzed (i.e., cleanly and quantitatively cleaved) under acidic conditions (e.g., treatment with warm acid) to form thiol end (—SH) 18 groups, forming a thiol end product 50 (denoted here as AC—CH₂—SH) in high yield (greater than 90% conversion efficiency). The thiol product 50 (AC—CH₂—SH) is a desired modified activated carbon product. (AC—CH₂—SH) is effective as a heavy metal sorbent, and efficiently captures various metals including, e.g., Hg, Pb, Ag and Cu. Sorption kinetics are rapid, with an equilibrium that is achieved in less than 30 minutes.

The chloromethylated intermediate 30 (AC—CH₂—Cl) is a versatile synthon. The term “synthon”, as used herein, means a chemically modified intermediate involving a basic structural component or chemical moiety of the carbon scaffold that is a key intermediate in a synthesis process to a desired end product. In general, the substitution reactions described herein involving the scaffold of activated carbon are nucleophilic displacement reactions. In the sorbents of the invention, desired ligands are easily constructed from the chloromethylated intermediate using S_{N}2-type reactions. For example, in the chloromethylation reactions, end groups within the activated carbon scaffold provide electrophilic attachment sites that are easily displaced by nucleophiles to create a diversity of chemical structures having desirable chemical properties (e.g., ligands that bind metal ions). Ligands include, but are not limited to, e.g., thiols, amines, and carboxylates. In the preferred embodiment, as a synthon, the chloromethylated intermediate forms an end product containing thiol end groups that exhibit a high affinity for selective capture of target metals. The chloromethylated intermediate 30 can also be displaced with a wide variety of other nucleophilic ligands including, but not limited to, e.g. phosphines, phosphites, phosphonates, enolates, carbanions, alkoxides, and thiolates to form a broad range of modified activated carbon end products that, e.g., bind with, e.g., a preselected metal or preselected metals (e.g., for removing metal ions in a fluid); with metal complexes; with other target materials; or that exhibit other desired properties. The chloromethylated intermediate 30 (AC—CH₂—Cl) has a rigid, open, nanoporous architecture that does not swell in the presence of liquids. The scaffold (backbone) of the chloromethylated intermediate is both thermally and chemically stable, making it useful for a wide variety of applications including, but not limited to, e.g., as heavy metal sorbents, as catalyst supports, and for applications in ion chromatography. Much of the functionality of the chloromethylated activated carbon is internal to (inside) the pores of the nanoporous architecture, indicating that size selective reactions are possible at these sites of the scaffold. While the activated carbon scaffold in the preferred embodiment is modified to include thiol groups, the invention is not limited thereto. For example, other chemical functional groups and molecular moieties originally present in the activated carbon material including, e.g., carboxylic acids, phenols, lactones, and other oxygen-bearing entities, are not removed during the preparation of the (AC—CH₂—SH) product. Thus, chemical properties of these chemical functional groups can be likewise exploited for other useful targets or applications, e.g., by modifying these respective chemical functional groups in the carbon scaffold or backbone of the activated carbon. All modifications to chemical functional groups of the carbon scaffold as will be implemented by those of skill in the chemical arts in view of this disclosure are within the scope of the invention. No limitations are intended by the description of the preferred embodiment.

### Distribution Coefficient (K_{d})

The distribution coefficient, (K_{d}), is one measure for assessing chemical utility of the (AC—CH₂—SH) product. The distribution coefficient, (K_{d}), is a mass-weighted partition coefficient (mL/g) between the solid phase and the liquid supernatant phase, as defined by Equation [1]:

$${K}_{d} = \frac{( {C}_{o} - {C}_{f} )}{{C}_{f}} \times \frac{V}{M} \qquad [ 1 ]$$

Here, (Cₒ) is the initial solution concentration of the target species, (C_{f}) is the final solution concentration of the target species, as determined by ICP-MS. (V) is the solution volume (mL), and (M) is the mass (g) of the sorbent. Experiments were conducted to test sorption of various metal cations by the thiol-functionalized (AC—CH₂—SH) product at various pH conditions relative to an activated carbon control. Results are listed in TABLE 1.

TABLE 1
Heavy metal sorption experiments using thiolated activated carbon
(AC—CH₂—SH). All experiments were performed in triplicate and averaged.

| | Final | Average Kd (mL/g sorbent) | | | | | | | |
|---|---|---|---|---|---|---|---|---|---|
| Sorbent | pH | Co(II) | Cu(II) | As(III) | Ag(I) | Cd(II) | Hg(II) | Tl(I) | Pb(II) |
| AC—CH₂SH | 0.17 | 280 | 260 | 180 | 1700 | 0 | 1600000 | 96 | 91 |
| | 2.02 | 160 | 260 | 78 | 1400 | 83 | 1100000 | 19 | 120 |
| | 4.31 | 120 | 2100 | 0 | 5800 | 270 | 1800000 | 110 | 1500 |
| | 6.37 | 1100 | 55000 | 160 | 62000 | 1400 | 2200000 | 560 | 86000 |
| | 7.33 | 1900 | 100000 | 0 | 340000 | 5000 | 6100000 | 1500 | 120000 |
| | 8.49 | 2100 | 88000 | 0 | 410000 | 4300 | 20000000 | 1700 | 110000 |
| Activated | 2.12 | 0 | 55 | 0 | 220 | 0 | 2600 | 73 | 170 |
| carbon | 4.22 | 110 | 5400 | 0 | 820 | 170 | 4800 | 250 | 6600 |
| | 7.61 | 1300 | 53000 | 23 | 3400 | 2900 | 9700 | 1800 | 67000 |

Initial metal conc = 100 ppb each;
Liquid per solid (L/S) ratio = 5000, in pH-adjusted filtered river water.

Results demonstrate that the (AC—CH₂—SH) product is effective for selective capture of target metals across a wide range of pH values.

### Kinetics

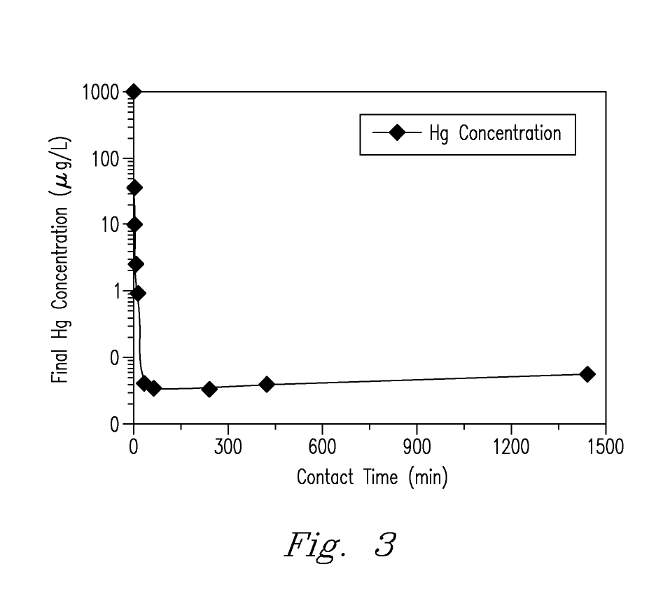

FIG. 3 is a plot that shows the kinetics of capture (sorption) of an exemplary metal (i.e., Hg) by the (AC—CH₂—SH) product. The test was conducted using a solution/solids ratio of 1,000 and a pH of ˜5. In the figure, capture of (Hg) metal by (AC—CH₂—SH) is rapid. Results show concentration of free (Hg) in the solution decreases to below ˜0.04 ppb in less than 30 minutes.

### Metal Binding (Sorption) Capacity

Binding affinity for capture of selected metals is principally a reflection of preselected ligands that interact with the selected metal species. Results show that the capacity of the thiolated activated carbon product (i.e., AC—CH₂—SH) for binding of heavy metals increases with increasing pH, and is particularly pronounced for such metals as Hg, Cu, Ag, and Pb above a pH of 6. Affinity for heavy metal binding also increases with increasing pH, especially for (Hg), suggesting that the (AC—CH₂—SH) products may find application as a sorbent for heavy metal capture under strongly alkaline conditions where conventional silica or polymer-based sorbents are chemically unstable.

Activated carbon commonly has a great deal of porosity, e.g., micro-scale porosity and nano-scale porosity. Thus, many available thiol functional groups or other end-group functionalities formed for the composition, may be anchored inside these micropores and nanopores. Some may thus be kinetically inaccessible. In the exemplary product, binding capacity for the instant (AC—CH₂—SH) sorbent was ˜33 mg (Hg) per gram of sorbent. Activated carbon containing fewer micropores may exhibit a greater (Hg) binding capacity. In addition, use of activated carbons that contain different functional or chemical groups or moieties may achieve a greater loading capacity for desired targets, whether metals or other selected chemical targets. No limitations are intended. All activated carbon scaffolds as will be employed and/or modified by those of skill in the art in view of this disclosure are within the scope of the invention.

The following examples will further assist the understanding of the invention in its broader aspects.

### EXAMPLE 1

### Surface Area of an Exemplary Activated Carbon

Activated carbon (Darco KB-B, 100 mesh) was purchased (Sigma-Aldrich, St. Louis, Mo., USA). BET measurements of this material showed it to have a surface area to mass ratio of 1437 m²/g. Results described herein are made in reference to this surface-to-area measurement for this activated carbon product only, which is not intended to be limiting to uses involving other activated carbon materials.

### EXAMPLE 2

### Chloromethylation of Activated Carbon

A three neck, 500 mL round bottom flask was fitted with a large magnetic stir bar, one rubber septum, one short path condenser attached to a gas manifold with both a silicon oil bubbler and inert gas supply and a glass dispersion tube connected to a tank of anhydrous HCl. The flask was charged with 10.0 g of activated carbon, and 0.50 g (3.7 mmole) of zinc chloride, and 250 mL of a 1:1 mixture of concentrated hydrochloric acid and acetic acid and stirred at 27° C. to dissolve the zinc chloride. Temperature was lowered to 0° C. under an argon atmosphere in an ice bath for three hours. Argon was stopped and HCl gas was vigorously bubbled through the suspension. 38.0 g (0.47 mole) of 37% (aq.) formaldehyde was added. Flow of HCl was continued for an additional four hours, following which the solution was warmed to 27° C. and stirred for an additional six hours. The chloromethylated product was collected on a glass frit, and washed with two 100 mL portions of water and three 100 mL portions of methanol. The collected cake was broken up and transferred to an open polyethylene container and dried at 50° C. and 0.25 atm for 36 hours. The final dried product weighed 11.75 g. The chloromethylated product had a surface area of 1357 m²/g, consistent with a modest mass increase. No discernable change in the pore structure was found, suggesting that the chloromethylation chemistry had not blocked or seriously degraded the pore structure. Elemental analysis for this exemplary activated carbon product revealed a chlorine (Cl) content of 5.21%, or approximately 1.46 mmole/g.

### EXAMPLE 3

### Displacement of Benzylic Chloride

Displacement of benzyl chloride with thiosulfate anion via S_{N}2 reaction gave a reasonable yield of a benzylic thiosulfate intermediate. The starting chloromethylated activated carbon contained 1.46 mmole/g of chlorine (Cl). Elemental analysis of the thiosulfate product revealed only 0.15% chlorine (Cl), indicating >97% of the benzylic chloride was consumed. The thiosulfate product was found to contain only 0.65 mmole/g of thiosulfate. Since ˜45% of the benzyl chloride was converted to the corresponding thiosulfate, the remainder was presumably consumed in another competing reaction process. Pore structure and surface area of the activated carbon were retained.

### EXAMPLE 4

### Hydrolysis of Thiosulfate to Thiol

2.50 g chloromethylated activated carbon prepared as in EXAMPLE 2 was suspended in 60 mL of methanol. Sodium thiosulfate (8.6 g; 35 mmole) was dissolved in 60 mL of reverse osmosis (RO) water and added to the reaction vessel. The mixture was heated to its boiling point for 2 hours, collected warm on a 0.45 μm nylon filter, washed with two 100 mL portions of RO water, and air dried. The crude thiol product was resuspended in 100 mL of 3.0N HCl and held at 80° C. for 12 hours in a sealed container. The suspension was stirred for 1 hour and returned to a temperature of 80° C. for an additional hour and filtered through a medium glass frit. Collected thiol-activated carbon product (AC—CH₂—SH) was washed with two 100 mL portions of RO water, and 100 mL methanol. The washed product was dried in vacuo at 0.75 atm for 18 hours at 25° C. yielding 1.78 g of material. Elemental analysis of the product revealed sulfur (S) content of 1.88%, corresponding to 0.59 mmoles thiol per gram of sorbent. Results indicate the hydrolysis reaction gave a greater than 90% yield, based on a functional density for the thiosulfate intermediate of 0.65 mmole/g.

### EXAMPLE 5

### Distribution Coefficient (K_{d}) Measurements

Filtered river water (Columbia River, Richland, Wash.) was spiked with 100 μg/L of metal ions (Co²⁺, Cu²⁺, As³⁺, Ag⁺, Cd²⁺, Hg²⁺, Tl⁺, and Pb²⁺). Solution pH was adjusted to desired values using 0.1 M HNO₃ and 0.1 M NaOH. After 30 min of incubation, 4.9 mL aliquots were introduced 20 mL polypropylene vials. Solution was spiked with 0.1 mL of a suspension of the solid (AC—CH₂—SH) sorbent and deionized distilled (DI) water at a liquid to solid (L/S) ratio (mL/g) of 100, giving a final L/S of 5,000. A control was prepared identically absent addition of solid sorbent. Samples were shaken for 2 hrs at 160 rpm on an orbital shaker. After 2 hrs, solution was removed by filtering thru 0.45-μm syringe Nylon-membrane filters and the filtrate was kept in 2 vol. % HNO₃ prior to metal analysis. Concentrations of each test solution (with sorbent material) and controls (no sorbent) were analyzed using an inductively coupled plasma-mass spectrometer (ICP-MS, Agilent 7500ce, Agilent Technologies, Calif.). All batch experiments were performed in triplicates and averaged values reported. The thiolated activated carbon sorbent was found to be effective for the removal of Cu(II), Ag(I), Cd(II), Hg(II), and Pb(II) at pH values between about 4 and about 8.

### EXAMPLE 6

### Sorption Capacity

Binding (sorption) capacity of the (AC—CH₂—SH) sorbent for individual metal ions was measured using K_{d} values, performed according to EXAMPLE 5. Experiments were conducted at a solution/solids ratio of 100,000, and a nominal pH of 5.5. In the (AC—CH₂—SH) system, the activated carbon scaffold has no consistent molecular pattern or order. Concentration of each metal in solution was varied until maximum sorption capacity was obtained. A large excess of metal ions was used relative to the number of binding sites on the sorbent material, e.g., 0.1 to 4 mg/L of metal ion at L/S of 100,000. In exemplary tests, binding capacity of the (AC—CH₂—SH) product for (Hg) metal was carried out. Binding capacity for Hg metal was found to be 33 mg Hg per gram of sorbent.

### EXAMPLE 7

### Sorption Kinetics

Kinetics of metal sorption by the (AC—CH₂—SH) sorbent was measured in the same fashion as with the equilibrium studies performed in EXAMPLE 5 except that 1 mL aliquots were removed and filtered at 0, 1, 2, 5, 10, 30, 60 min, 4, 7, and 24 hr. The initial sample volume was increased to 100 mL to minimize the change in US. The sorbent was able to reduce the Hg concentration to below 0.04 ppb in less than 30 minutes.

### CONCLUSIONS

This work has demonstrated that it is easy to generate a chloromethylated activated carbon from inexpensive, readily available starting materials. The level of chloromethylation does not appear to negatively impact surface area or pore structure of the activated carbon. The benzylic-chloride moiety is readily displaced by nucleophiles, affording easy access to chemically modified activated carbons. The activated carbon product (AC—CH₂—SH) is easily decorated with ligands that include, e.g., thiol groups, which has been shown to be useful as a heavy metal sorbent. Tests with mercury indicate the sorbent is fast, effective, and easily capable of reducing (Hg) concentrations down to well below ppb levels (e.g. 0.04 ppb). Sorption kinetics of (AC—CH₂—SH) for (Hg) metal are much faster than those observed for many conventional sorbents including, e.g., sulfur-impregnated activated carbon. The activated carbon backbone provides excellent chemical and thermal stability to the AC—H₂₋SH sorbent, and has been shown to enhance the sorbent's affinity for heavy metals under alkaline conditions. Binding capacity measurements using (AC—CH₂—SH) for capture of (Hg) metal suggests that a portion of the thiol groups may be in kinetically inaccessible micropores. The (AC—CH₂—SH) product of the invention is expected to prove useful under conditions where silica-based sorbents are not well-suited including, e.g., strongly alkaline conditions.

While an exemplary embodiment of the present invention has been shown and described, it will be apparent to those skilled in the art that many changes and modifications may be made without departing from the invention in its true scope and broader aspects. The appended claims are therefore intended to cover all such changes and modifications as fall within the spirit and scope of the invention.

We claim:

1. A composition, characterized by:
a scaffold of activated carbon that includes a preselected nucleofugic (leaving) group that is chemically attached to a preselected chemical group of said scaffold.

2. The composition of claim 1, wherein said nucleofugic group is selected from the group consisting of: —Cl, —Br, —I, sulfates, organosulfonates, tosylates, mesylates, and combinations thereof.

3. The composition of claim 1, wherein said nucleofugic group is a chloride leaving group bound to a pendant alkyl group.

4. The composition of claim 3, wherein said alkyl group is selected from the group consisting of: chloromethyl, chlorethyl, chloropropyl, and chlorobutyl, and combinations thereof.

5. The composition of claim 1, wherein said chemical group of said scaffold is a benzylic carbon.

6. The composition of claim 5, wherein said nucleofugic group is displaced with a sulfur-containing nucleophile selected from the group consisting of: thiosulfate, thiourea, thioacetate, and combinations thereof.

7. The composition of claim 6, wherein said nucleophile is hydrolyzed to form a thiol ligand that is chemically attached to said benzylic carbon of said scaffold.

8. The composition of claim 1, wherein said nucleofugic group is displaced with a nucleophile to form an anchored ligand selected from the group consisting of: thiols, amines, carboxylates, phosphines, phosphites, phosphonates, enolates, carbanions, alkoxides, thiolates, and combinations thereof.

9. The composition of claim 8, wherein said anchored ligand is a thiol that provides selective capture of a metal selected from the group consisting of: heavy metals, toxic metals, transition metals, rare earth metals, and combinations thereof.

10. The composition of claim 9, wherein said anchored ligand is a thiol that provides selective capture of a metal selected from the group consisting of: mercury (Hg), lead (Pb), cadmium (Cd), silver (Ag), copper (Cu), cobalt (Co), arsenic (As), and combinations thereof.

11. The composition of claim 1, wherein said activated carbon scaffold has a surface area selected in the range from about 800 m²/g to about 2500 m²/g.

12. The composition of claim 1, wherein said scaffold includes a surface area greater than about 1200 m²/g.

13. The composition of claim 1, wherein said scaffold includes pores of a size selected in the range from about 1 nm to about 100 nm.

14. A method of making a sorbent composition, comprising the steps of:
chemically attaching a preselected nucleofugic group to a preselected chemical group of an activated carbon scaffold; and
displacing said nucleofugic group and chemically attaching a preselected ligand to said scaffold that provides for selective capture of a preselected metal(s) or chemical(s).

15. The method of claim 14, wherein the step of chemically attaching includes use of a chloromethylation process or reagent.

16. The method of claim 15, wherein the step of displacing said nucleofugic group includes attaching a thiosulfate end group to said scaffold.

17. The method of claim 16, further comprising the step of converting said thiosulfate end group to form a thiol end group.

18. A method of using a sorbent composition, characterized by the step of:
chemically binding a preselected metal(s) or chemical present in a fluid to said sorbent composition comprised of an activated carbon scaffold that is chemically modified to include a preselected ligand, said ligand attached to said scaffold provides selective capture of said preselected metal(s) or chemical from said fluid.

19. The method of claim 18, wherein said ligand is a thiol ligand that is chemically attached to a benzylic carbon of said scaffold.

20. The method of claim 18, wherein the step of chemically binding includes chemically binding a metal selected from the group consisting of: mercury (Hg), lead (Pb), cadmium (Cd), silver (Ag), copper (Cu), cobalt (Co), arsenic (As), and combinations thereof.
